(19) United States
(12) Patent Application Publication
(10) Pub. No.: US 2016/0125528 A1
(43) Pub. Date: May 5, 2016

(54) AFFORDABILITY ASSESSMENT

(71) Applicant: Michael Theodore Brown, Walnut, CA (US)

(72) Inventor: Michael Theodore Brown, Walnut, CA (US)

(21) Appl. No.: 14/530,508

(22) Filed: Oct. 31, 2014

(51) Int. Cl. G06Q 40/02

(52) U.S. Cl. CPC G06Q 40/025

(57) ABSTRACT

Briefly, embodiments of methods and/or systems of providing an affordability assessment are disclosed. For one embodiment, as an example, a method may comprise an individual submitting a query to one or more credit reporting bureaus (CRBs). A query may comprise a “soft inquiry.” A soft inquiry may preserve integrity of a credit bureau score (CBS) for the individual.

### BACKGROUND

1. Field

The present disclosure relates generally to assessing affordability and/or creditworthiness in connection with, for example, obtaining a loan for purchasing an item that may represent a large expenditure.

2. Information

In seeking to obtain real estate, one or more automobiles, and/or other purchase that may represent a large expenditure, an individual may attempt to secure a loan so that the individual may purchase the item. Typically, securing a loan involves an individual supplying various parameters, which may include personal identification parameters (e.g., Social Security number, date of birth, etc.), annual income, savings, assets, liabilities, monthly obligations, and so forth. In response to receiving various parameters relating to an individual's financial condition, a loan officer, which may represent a lender, for example, may perform inquiries to one or more credit-reporting bureaus. Responsive to inquiries, a credit reporting bureau may provide an indication of the individual's financial condition, which may influence a lender's decision to provide a loan to the individual, which may thus enable the individual to purchase the item.

### BRIEF DESCRIPTION OF DRAWINGS

Claimed subject matter is particularly pointed and/or distinctly claimed in the concluding portion of the specification. However, both as to organization and/or method of operation, together with objects, features, and/or advantages thereof, claimed subject matter may be understood by reference to the following detailed description if read with the accompanying drawings in which:

FIG. 1 is a schematic illustration of a mobile device interacting with an affordability assessment server to obtain an affordability certificate for an individual according to an embodiment;

FIG. 2 is a schematic illustration of a mobile device interacting with an affordability assessment server to obtain a notification of a change in an affordability assessment and/or creditworthiness according to an embodiment;

FIGS. 3A, 3B, 3C, 3D, 3E, and 3F are illustrations of menu-driven displays for a mobile device according to an embodiment; and

FIG. 4 is an illustration of an embodiment of a system that may be employed in a mobile client-server type interaction according to an embodiment.

Reference is made in the following detailed description of the accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Operations and/or processing, such as in association with networks, such as computing and/or communications networks, for example, may involve physical manipulations of physical quantities. Typically, although not necessarily, these quantities may take the form of electrical and/or magnetic signals capable of, for example, being stored (e.g., using non-transitory storage media), transferred, combined, processed, compared, and/or otherwise manipulated. It has proven convenient, at times, principally for reasons of common usage, to refer to these signals as bits, data, values, elements, symbols, characters, terms, numbers, numerals and/or the like. It should be understood, however, that all of these and/or similar terms are to be associated with appropriate physical quantities and are intended to merely be convenient labels.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B, or C, is intended to mean A, B, and C, here used in the inclusive sense, as well as A, B, or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term “network device” refers to any device capable of communicating via and/or as part of a network and may comprise a computing device. While network devices may be capable of sending and/or receiving signals (e.g., signal packets), such as via a wired or wireless network, they may also be capable of performing arithmetic and/or logic operations, processing and/or storing signals, such as in memory as non-transitory physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, integrated devices combining two or more features of the foregoing devices, the like or any combination thereof. Signal packets, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, mobile client device, client computing device, client computing platform and/or similar terms are also used interchangeably. While in some instances, for ease of description, these terms may be used in the singular, such as by referring to a “client device” or a “server device,” the description is intended to encompass one or more client devices or one or more server devices, as appropriate. Along similar lines, references to a “database” are understood to mean, one or more databases and/or portions thereof, as appropriate. It should be understood that for ease of description, a network device may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of computer and/or machine readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent.

The Internet refers to a decentralized global network of interoperable networks that comply with the Internet Protocol (IP). It is noted that there are several versions of the Internet Protocol. Here, the term Internet Protocol or IP is intended to refer to any version, now known and/or later developed. The Internet includes local area networks (LANs), wide area networks (WANs), wireless networks, and/or long haul public networks that, for example, may allow signal packets and/or frames to be communicated between LANs. The term world wide web (WWW or web) and/or similar terms may also be used, although it refers to a sub-portion of the Internet that complies with the Hypertext Transfer Protocol or HTTP. For example, network devices may engage in an HTTP session through an exchange of Internet signal packets and/or frames. It is noted that there are several versions of the Hypertext Transfer Protocol. Here, the term Hypertext Transfer Protocol or HTTP is intended to refer to any version, now known and/or later developed. It is likewise noted that in various places in this document substitution of the term Internet with the term World Wide Web and may be made without a significant departure in meaning and may, therefore, not be inappropriate in that the statement would remain correct with such a substitution.

The term “website” and/or similar terms refer to a collection of related web pages, in an embodiment. The term “web page” and/or similar terms refers to any electronic file and/or electronic document, such as may be accessible via a network, by specifying a uniform resource locator (URL) for accessibility via the web, in an example embodiment. As alluded to above, a web page may comprise content coded using one or more languages, such as, for example, HTML and/or XML, in one or more embodiments. Although claimed subject matter is not limited in scope in this respect. Also, in one or more embodiments, developers may write code in the form of JavaScript, for example, to provide content to populate one or more templates, such as for an application. Here, JavaScript is intended to refer to any now known or future versions. However, JavaScript is merely an example programming language. As was mentioned, claimed subject matter is not limited to examples or illustrations.

As a way of illustration, a “mobile device,” may refer to, for example, a cellular telephone, a smart phone, a personal digital assistant, a wearable computer, a wrist phone, a laptop computer, a personal entertainment system, a tablet personal computer, a personal audio and/or video device, a personal navigation device, as well as other types of mobile or at least occasionally mobile computing and/or network devices. It should be appreciated, however, that these are merely examples of mobile devices that may be used, at least in part, to implement one or more services described herein, such as instant messaging, electronic mail, for example, and that claimed subject matter is not limited in this respect. To permit a mobile device to perform one or more services, a server, for example, may perform one or more operations based, at least in part, on executable instructions (e.g., capable of being executed by a processor or other computing device), such as software and/or firmware, for example. It is noted that terms, such as “operation,” and “function,” and/or similar terms may be used interchangeably in this context.

As the term may be used herein, a client computing device, which may comprise a mobile device, for example, may receive, store, and/or transmit one or more “cookies” that may serve and/or function as an identifier to identify a user of a client device, for example, to one or more servers with which the mobile client device may communicate. In this context, a cookie may, for example, comprise any combination of binary digital signals, such as electronic transmissions, and/or physical states, such as memory states, that may be employed to identify a particular user and/or an account of a particular user, for example. A user cookie, or other type of identifier, may not necessarily be unique by itself; however, the term “user cookie,” or simply “cookie,” in this context may include several parameters and/or identifiers that, if taken together, may be employed to correspond with a particular Internet user and/or a particular Internet user account, such as, for example, in connection with an Internet service, as an example. In particular embodiments, again, as non-limiting illustrative examples, a cookie and/or other set of parameters, may be transmitted by a server to a browser and which may be returned by the browser as a result of subsequent server access, for example. In particular embodiments, a cookie may be used to identify a user, such as Internet user, for example, and/or track and a user's access to a server. It should be noted, however, that a cookie is contemplated as representing any number of possible approaches toward identifying users of a network and/or other entities and claimed subject matter is not limited to any particular approach.

As used herein, one or more parameters and/or similar terms refer to physical signals and/or physical states that comprise descriptive content. As one example, parameters may be descriptive of a collection of signal samples, such as one or more electronic documents. For example, one or more parameters may refer to an electronic document comprising a photographic image may include parameters, such as time of day at which a photographic image was taken, latitude and longitude of an image capture device, such as a camera, for example. In another example, one or more parameters relevant to content comprising a technical article may include one or more authors, for example. Likewise, parameters may comprise content descriptive with respect to an individual, such as social security number, income, address, etc. Claimed subject matter is intended to embrace meaningful, descriptive parameters in any format, so long as the one or more parameters comprise physical signals and/or states, which may include, as parameter examples, a name of a collection of signals and/or states, a logical path of an electronic document (or portion thereof), content identifying an individual, etc.

In certain embodiments, without limitation, determinations of affordability and/or credit worthiness may be made utilizing a score. Of course, where scoring is used, one or more components may be measured, estimated and/or quantified to produce a score. Here, it is noted that for a particular measurement, such as measurement of affordability and/or creditworthiness of an individual, for example, a typical measurement model employed is that a measurement taken comprises a sum of at least two components, a deterministic component, which in an ideal sense, comprises a value sought as a result of taking a measurement, and a random component, which may have a variety of sources that may be challenging to quantify accurately. Thus, a statistical model may be used.

Statistical models relate to uncertainty. In general, it is desirable to reduce uncertainty, if possible, even if it cannot be eliminated entirely. Along these lines, a variety of techniques have come into use so that measurements may be processed to better estimate an underlying deterministic component, as well as realized random components, typically. Employing a model permits collected measurements to be processed to estimate an underlying deterministic component. Although a given estimate may not be a perfect estimate, such as, if it may change, for example; nonetheless, in general, it is expected that on average an estimate may better reflect an underlying deterministic component if random components that may be included in measurements are considered. Practically speaking, of course, it is desirable to be able to generate, such as through estimation approaches, a meaningful model of processes affecting measurements. For example, it may be desirable to seek credit reporting scores from more than one source, as mentioned. For example, the scores may be averaged or otherwise adjusted in some way.

In such situations, it is also not unusual to employ heuristics in connection with generating estimates. Heuristics refers to use of experience related approaches that may reflect realized processes and/or realized results, such as in connection with use of historical measurements, for example. Heuristics, for example, may be employed in situations, such as this, where more analytical approaches may be overly complex and/or nearly intractable to implement computationally. Thus, seeking other parameters to combine with credit bureau scores, such as income, debt, etc., may also be employed in order to address uncertainty in a measurement, again, as mentioned.

As previously mentioned herein, individuals may, at times, seek to obtain one or more units of real estate (e.g., a house, apartment building, acreage, or a combination thereof), one or more automobiles, a business, and/or other purchase that may represent a large expenditure. Typically, an individual may engage a lending institution so that funding may be secured, thereby enabling the individual to obtain, for example, a dwelling, such as house, which may represent the individual's primary or secondary residence. Also, typically, to obtain funding, an individual may supply personal identification parameters, such as a Social Security number, taxpayer identification number, date of birth, and so forth. Additionally, an individual may be requested to supply financial status parameters that relate to the individual's financial condition, such as monthly income, monthly expenditures, savings, debts, and so forth. It is noted that personal identification parameters, in this context, include financial status parameters. These parameters may be assembled, along with an individual's credit bureau score (referred to herein as ‘CBS’), as illustrated below in various example embodiments, and/or other indications of the individual's creditworthiness, for presentation, such as to a lending institution, such as a credit union, bank, etc.

In one or more embodiments, a CBS may be obtained so that an individual is able to obtain a low-cost (e.g., free) measurement of the individual's creditworthiness. However, in other embodiments, a CBS may be accompanied by a more exhaustive credit report, which may comprise, for example, active credit accounts, inactive credit accounts, past credit activity, bankruptcies, and so forth. One or more embodiments may include obtaining a credit report without obtaining, for example, a CBS, and/or may include obtaining a summarized credit profile and/or credit summary. For example, as discussed below, a CRB report may or may not include a CBS. In other embodiments, in place of, or in addition to a CBS, another type of risk measurement, such as credit risk measurement, for example, may be obtained. In other embodiments, a CBS may be provided to an individual free of charge, and a more detailed credit report may be offered for a fee.

As the term is used herein, a “query,” or “submitting a query,” and/or similar terms, refers to making a request for content electronically, including descriptive content, such via an electronic communication, but is otherwise not intended to be limited to a particular format or approach. Thus, a query is not limited to use of an application program interface (API), for example. In general, under Section 604 of the Fair Credit Reporting Act (FCRA) [15 U.S.C. §1681 b], which was enacted to be a part of the Fair Credit Reporting Act (FCRA), a lender may, for example, query a credit reporting bureau (referred to herein as ‘CRB’) as a “permissible purpose” in connection with supporting a lender's business decision to extend credit to an individual. However, if a lender, such as a lender who does not have an existing business relationship with an individual, for example, queries a credit reporting bureau (CRB), such as Equifax, Trans Union, and/or Experian, the CRB may make a record of such a request on the individual's credit report. In general, this may occur since the lender will make a business decision based at least partially on the CBS provided for the individual. Typically, therefore, in this context, a query from a lender in connection with the lender's permissible purpose is referred to as a “hard inquiry.”

Occasional and/or isolated inquiries as part of a lender's permissible purpose may have a small negative impact on an individual's credit bureau score (CBS); however, repeated inquiries may noticeably degrade an individual's CBS. Hence, if an individual attempts to obtain credit for one or more purchases that may represent a large expenditure, the individual may be denied credit and/or may be unable to obtain credit at favorable terms. Favorable terms may comprise, for example, a relatively low interest rate, a relatively low down payment, and/or other desirable features, which may be offered, perhaps exclusively, to individuals having above-average creditworthiness. It should be noted that lender queries to CRBs may impact an individual's CBS in other ways; it is not intended that claimed subject matter exclude those possibilities.

As the term is used herein, the term CRB (credit reporting bureau) refers to a consumer reporting agency (CRA) under the FCRA. For example, there are currently three in the United States, Equifax, Trans Union, and/or Experian. These entities collect credit histories and generate credit reports for individuals that are to be used, for example, by lenders, creditors, and/or consumers. Likewise, in the context, a CRB report refers to reporting of any CRB generated parameters in response to a query. Thus, a CRB report may comprise reporting of a credit bureau score, but may also comprise reporting of other credit-related content generated by a CRB other than a CBS. Nonetheless, in particular, a credit bureau score (CBS) refers to a score for an individual generated by a CRB. Thus, a CBS (credit bureau score) comprises a statistically derived numeric expression of an individual's creditworthiness that is generated by a CRB and is used by lenders, for example, to access likelihood that an individual will repay his or her debts. A CBS is based on, among other things, an individual's past credit history. A higher credit score provides an indication of the individual's increased creditworthiness.

However, under particular circumstances, certain queries to a CRB may not have a negative impact on an individual's CBS. As the term is used herein, a “soft inquiry” refers to a query of a CRB that does not degrade or otherwise negatively impact an individual's CBS. An example of a soft inquiry comprises, for example, an individual querying a CRB on his or her own behalf, which may be referred to as a “self-inquiry.” Thus, an example of a self-inquiry may comprise, for example, an individual obtaining a no-cost credit report per year as provided in the United States by the Fair and Accurate Credit Transaction Act of 2003 (FACT Act or FACTA, Public Law 108-159, 108th Congress). Another example of a soft inquiry may comprise a lender making a query to a CRB with respect to an individual where the lender has an existing business relationship with that individual. In other instances, a soft inquiry may possibly be recorded or annotated on an individual's credit report but in a manner that does not degrade or otherwise undesirably impact an individual's CBS. In one or more embodiments, an individual may likewise consent to or authorize an agent (e.g., an authorized agency including an employee or agent of an authorized agency) to initiate one or more self-inquiries to a CRB on the individual's behalf, such as for the purpose of checking his or her own credit score.

Thus, in embodiments of claimed subject matter, an individual may initiate a self-inquiry to one or more CRBs, such as in connection with checking the individual's own credit score, for example. Responsive to checking an individual's credit score, for example, and/or otherwise checking on credit-related content being reported by a CRB about him or her, an individual may consent to share a result of a self-inquiry with, for example, a real estate agent, a lender, a representative of a title company, and so forth. In embodiments, a CBS, having been obtained, may be combined with other measured parameters to comprise an individual's financial state (e.g., financial status parameters), such as annual and/or monthly gross income, annual and/or monthly debts, annual and/or monthly financial obligations (e.g., automobile loan payments, student loan payments, utility bills, or the like), and may therefore be used to decide whether to issue an affordability assessment and/or an affordability certificate. In embodiments, an affordability assessment and/or affordability certificate may be utilized to indicate a CBS and/or an indication that an individual is likely capable of meeting financial obligations imposed by expected loan terms and/or conditions. In other embodiments, an affordability assessment and/or affordability certificate may be computed by determining and/or estimating an individual's probability of repaying a loan balance, an individual's probability of loan default, an individual's CBS, and so forth. Thus, claimed subject matter is intended to embrace a wide variety of situations that may involve generating an affordability assessment and/or affordability certificate.

In a particular embodiment, an affordability assessment and/or affordability certificate may be utilized to obtain credit and/or obtain prequalification by a lender for a home mortgage loan, such as for an individual's primary or secondary residence. In another embodiment, an affordability assessment and/or affordability certificate may be utilized to obtain credit to purchase one or more vehicles, such as an automobile, an aircraft, a watercraft, and so forth. An affordability assessment and/or affordability certificate may be utilized to obtain credit to purchase one or more businesses, such as a retail establishment, café, restaurant, and/or any other purchase that may represent a large expenditure. In another embodiment, an affordability assessment and/or affordability certificate may be utilized to obtain relatively unsecured credit, such as by issuance of one or more credit cards, one or more lines of credit and/or other financial instruments, which may permit an individual to purchase unspecified materials and/or capital equipment, consumable business supplies, and so forth, just to name a few examples.

In some embodiments, seller, or seller's representative, such as a real estate agent, for example, may appreciate and/or benefit from a perspective buyer's presentation of an affordability assessment and/or affordability certificate. In at least some instances, if a prospective buyer secures an affordability assessment and/or affordability certificate, it may be likely that the prospective buyer is indeed interested in purchasing, for example, real estate that may represent a large expenditure. In these instances, a real estate agent, for example, may benefit from knowledge that not only is the prospective buyer interested in a property, for example, but that the prospective buyer is earnest in his or her desire to obtain credit and/or become creditworthy so that the transaction may be brought to its completion.

In certain embodiments, if an affordability assessment and/or affordability certificate is not issued, the individual may be offered an opportunity to restore and/or improve his or her creditworthiness. In one possible embodiment, just for the sake of illustration, credit restoration may be offered responsive to a CBS and/or other indication directly and/or indirectly related to an individual's creditworthiness, such as a Fair Isaac Corporation (FICO) score that approaches approximately 500 or below, for example. In other possible embodiments, scoring approaches in addition to or in place of a FICO score, such as Beacon, TransRisk, Experian PLUS, VantageScore, or the like may be utilized. Credit restoration may involve, for example, correcting inaccurate creditor reports, contacting creditors, and so forth, and claimed subject matter is not limited in this respect.

In certain embodiments, if an affordability assessment and/or affordability certificate indicates that an individual is assessed, pending lender approval, as being sufficiently creditworthy to obtain, for example, one or more units of real estate, one or more vehicles, and/or one or more other purchases representing a large expenditure, the individual may elect to receive additional offers for purchases representing comparable items. Thus, in one possible embodiment, if an individual receives an affordability assessment and/or affordability certificate, which may permit the individual to purchase a dwelling, the individual may receive offers to purchase a dwelling having similar features, perhaps in a nearby neighborhood, which may be offered at an approximately similar purchase price, and may be obtained the same real estate agent, for example. Such offers may mutually benefit to prospective homeowners and real estate agents. Prospective homeowners may have missed an opportunity to purchase a desired dwelling, for example, as may occur from time to time in highly active real estate markets, for example, in which average times to sell may be measured in mere hours or fractions of days.

Likewise, a real estate agent may benefit by permitting additional categorization and/or filtering of potential customers in a customer relations management (CRM) system, for example. In a CRM system, a potentially creditworthy individual may be switched, for example, to a “hot lead” from a less active customer category. In another example, a real estate agent may utilize a CRM to filter individuals by a certain range of credit score, a range of credit grades, and/or an affordability amount, for example. Responsive to modifications of a CRM system, a real estate agent may more easily generate a sale.

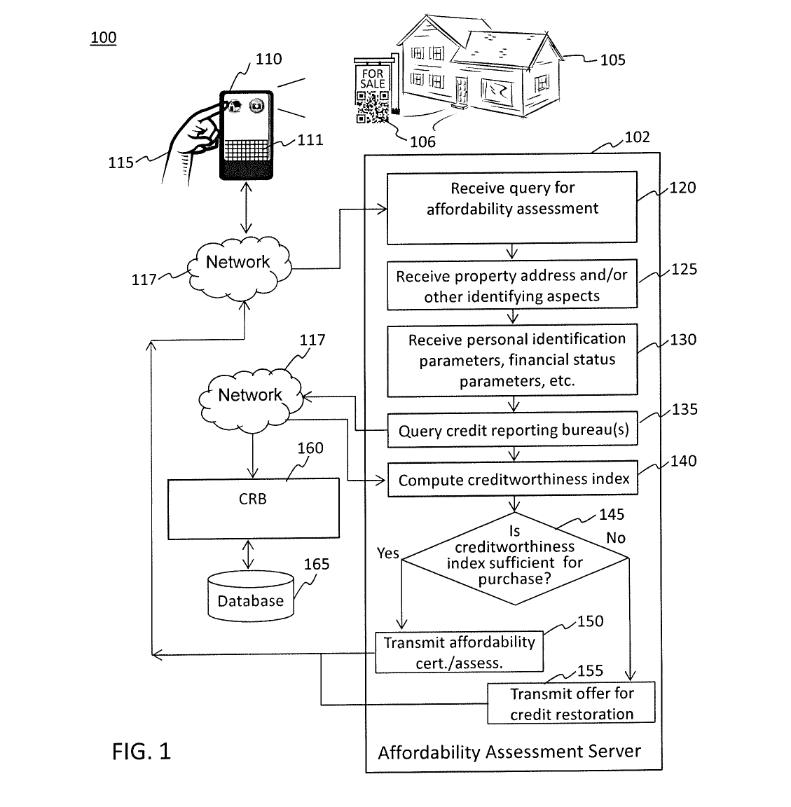

FIG. 1 is a schematic illustration of a mobile device interacting with an affordability assessment server to obtain an affordability assessment according to an embodiment 100. As shown in FIG. 1, individual 115, which may be represented by an individual's hand and forearm, is shown operating a mobile application or “mobile app” that enables the individual to access a website, for example, that provides listings of homes for sale. It should be noted that although the embodiment of FIG. 1 is described in the context of individual 115 operating a “mobile app,” other embodiments may utilize one or more desktop applications, one or more website applications, one or more mobile-friendly websites, and so forth, and claimed subject matter is not intended to be limited in this respect. For example, an embodiment may include an “offline mode” in which personal identification parameters, such as name, phone, email, etc., may be collected without a network connection to an affordability assessment server. Parameters may be stored locally until a network connection is available. After a network connection becomes available, locally stored parameters may be forwarded to an affordability server, which may send the individual a link to complete an online affordability assessment, for example. Alternatively, in an embodiment, a real estate agent may forward a link via an electronic transmission, such as email, to a web portal (e.g., website) so that an individual interested in a creditworthiness assessment is able to access an affordability assessment server, for example.

In other embodiments, a mobile application operating on mobile device 110, for example, may permit access to additional websites, such as those that include listings of other items that may represent large expenditures, which may include other units of real estate (e.g., commercial properties, apartment buildings, acreage, and so forth), businesses properties (e.g., eating establishments, retail outlets, and so forth, vehicles (e.g., watercraft, aircraft, and so forth) and/or a variety of articles which may represent large expenditures, for example. In embodiments, an item that may represent a large expenditure, such as house 105, for example, may motivate individual 115 to obtain or secure credit, so that the individual may more easily purchase house 105.

In FIG. 1, a mobile application executing by way of one or more processors of mobile device 110 and/or a web portal (e.g., website) may enable individual 115 to enter a physical address of, for example, house 105 by utilizing virtual keyboard 111, for example. In embodiments, electrical signals or impulses representing, for example, binary digits corresponding to a physical address of the house 105 may be transmitted to affordability assessment server 102 by way of network 117. In one or more embodiments, affordability assessment server 102 may include hardware and software modules, which bring about a capability to provide affordability assessments and/or affordability certificates based at least in part on a number of parameters provided by individual 115, as well as parameters made available by CRB 160, such as a CBS. In embodiments, network 117 may represent the Internet, for example, or may be representative of any other type of packet-switched network such as an Ethernet, a virtual private network, and so forth.

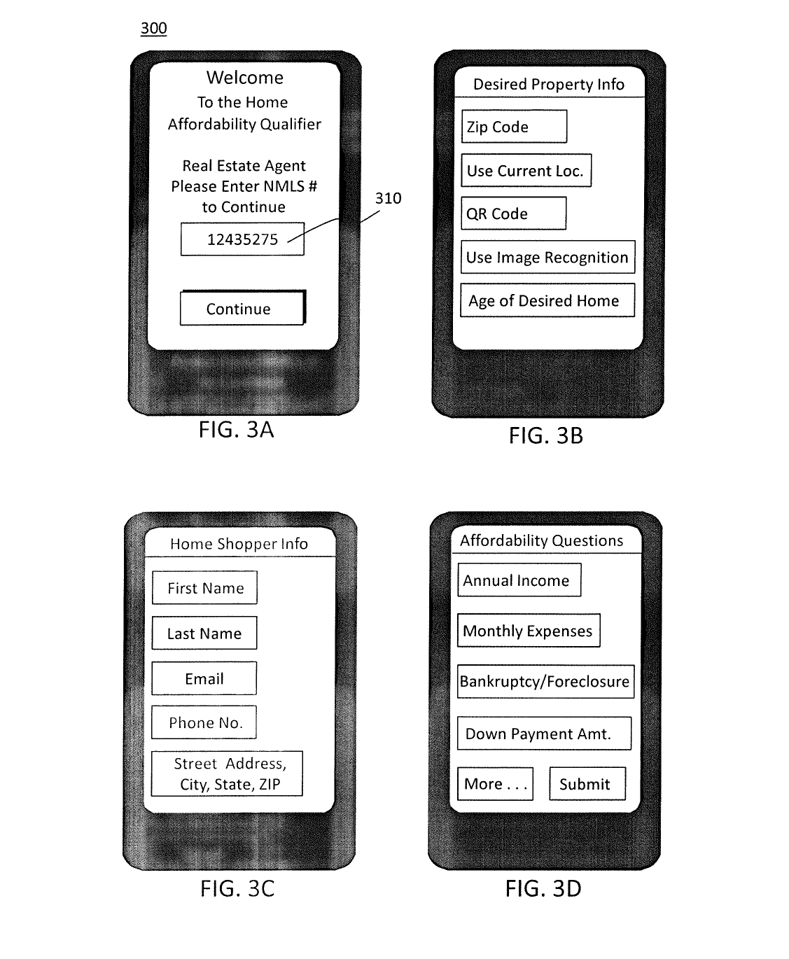

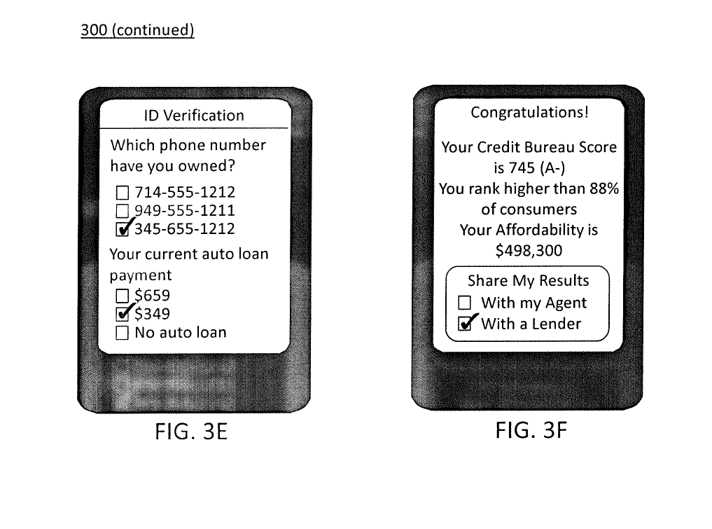

In particular embodiments, a mobile application executing on mobile device 110 and/or a web portal (e.g., website) may permit reading of a quick response (QR) code, such as quick response code 106, which may be converted into electrical signals representing parameters that uniquely identify house 105 and/or that uniquely identify a real estate agent for the house listing, for example, to affordability assessment server 102. Affordability assessment server 102 may determine location parameters of house 105 responsive to receipt of electrical signals representing quick response code 106. Thus, in an embodiment, as illustrated, for example, by FIG. 3, a house of interest may be identified in connection with affordability assessment questions asked of an individual seeking an assessment.

In another embodiment, house 105 may be photographed and identified utilizing image or object recognition application, such as may operate on mobile device 110. A recognition application may operate by utilizing, for example, a scale invariant transform in which keypoints and/or features may be extracted from one or more captured images of the exterior of house 105. Keypoints and/or features may be quantized into image descriptors generated using a speeded-up-robust-features (SURF) process. Extracted keypoints and/or features may be converted into SURF descriptors, for example, and/or may be processed using a Scale-Invariant Feature Transform (SIFT), a Histogram of Oriented Gradients (HoG), Gradient Location Orientation Histogram (GLOH), and/or color SIFT, just to name a few examples. Descriptors of extracted keypoints and/or features may be compared with descriptors stored in a reference image database (not shown in FIG. 1) until a match between extracted keypoints and/or features of house 105 and one or more reference images is found. If a reference image is found, parameters corresponding to the reference image may be transmitted utilizing network 117 for display on mobile device 110. Responsive to determining that a transmitted reference image corresponds to a house in view of mobile device 110, such as house 105, individual 115 may verify that the reference image indeed corresponds to house 105. Responsive to receiving verification from a user interface, for example, that a reference image corresponds to house 105, a real estate database may transmit a sale price, for example, along with other parameters, such as square footage, lot size, number of bedrooms/bathrooms, and so forth, to mobile device 110.

In another embodiment mobile device 110 may be capable of estimating its location utilizing, for example, signals from one or more space vehicles of a satellite positioning system, such as the Global Positioning System, for example. Thus, user 115 may locate mobile device 110 proximate with house 105, such as during a viewing of house 105, thereby permitting mobile device 110 to estimate a location (e.g., latitude and longitude) of house 105. Responsive to estimation of latitude and longitude, for example, of house 105, mobile device 110 may transmit an estimated location to a real estate database (not shown in FIG. 1), for example. A real estate database may compare location parameters of an object, such as house 105, and may respond by transmitting a physical address, image, sale price, and/or other parameters of a house or other object that matches the estimated location to mobile device 110. It should be noted that additional approaches toward identifying and/or locating house 105 may be employed, and claimed subject matter is not limited to any particular recognition and/or identification technique. For example, in one or more embodiments, an address of house 105 may be transmitted, from a real estate agent through a wireless communications channel to mobile device 110.

In embodiments, responsive to ascertaining location parameters of house 105, individual 115 may transmit electrical signals to affordability assessment server 102 indicating the individual's interest in, for example, obtaining credit to purchase house 105. In one possible embodiment, individual 115 may enter a number of personal identification parameters, such as legal name, Social Security number and so forth, which may also include financial status parameters, such as annual income, savings, assets, liabilities, and so forth. Transmitted parameters may be received by server 102 along with a query and/or request for an affordability assessment, such as at block 120. Thus, as previously indicated, in an embodiment, for example, a house of interest may be located in connection with posing of affordability assessment questions. Likewise, it is noted that FIG. 1 includes blocks, such as 120-155, in a flowchart-type form for an example embodiment. Of course, embodiments in accordance with claimed subject matter may include all of blocks 120-155, fewer than blocks 120-155, or more than blocks 120-155. Also, the order of blocks 120-155, depicted in FIG. 1, is merely an example order, and claimed subject matter is not limited in scope in these respects.

At block 125, server 102 may receive a physical address for house 105 and/or additional identifying aspects, such as latitude and longitude. In other embodiments, a physical address for house 105 may comprise a legal description of a property (e.g., fractional designations, metes and bounds, courses and distances, tract part, subdivision lot, and so forth), although claimed subject matter is not limited in this respect. At block 130, server 102 may receive personal identification parameters, such as financial status parameters, and so forth, which may be relevant to individual 115. At block 135, server 102 may transmit a query, utilizing network 117, to a CRB 160, such as Trans Union, Equifax, and/or Experian. In other embodiments, CRB 160 may be substituted by a surrogate or other type of intermediary that interacts directly or indirectly with one or more CRBs, although claimed subject matter is not limited in this respect. In one or more embodiments, substituting CRBs with a single intermediary may be beneficial in that affordability assessment server 102 may communicate with an intermediary utilizing, for example, a single application program interface (API) rather than multiple APIs corresponding to separate CRBs.

CRB 160, or a designated intermediary, for example, may operate to access a database 165 to obtain one or more CBSs for individual 115. In particular embodiments, database 165 may be representative of multiple databases, which may correspond to discrete databases for separate CRBs (e.g., Trans Union, Equifax, and/or Experian). In other embodiments, database 165 may represent a single database comprising an aggregation with respect to separate CRBs for individual 115. In other embodiments, database 165 may be organized in an alternative manner, which may comprise interacting with additional databases (not shown in FIG. 1) to obtain other types of credit reports and/or other types of credit scores (e.g., other than CBSs) for, or corresponding to, individual 115.

In an embodiment, a credit report with one or more CBSs may be obtained, such as via an electronic query communicated via an electronic transmission (e.g., email). A CBS generally comprises a numerical score and may be used to generate a creditworthiness index and/or a credit “grade,” such as A, AA, BA, BB, C, D, and so forth. However, it should be noted that any credit scaling scheme may be utilized for a credit worthiness index and/or credit grade, such as signal samples having a value between 0.0 and 100.0, just as one possible example among a myriad of credit scoring and/or credit scale possibilities. In other embodiments, a scale may comprise grades (e.g., a credit grade), which may be accompanied by a modifier such as “−” or a “+,” which may enable a grade to be expressed as “A+,” “A−,” “B+,”, etc., for example. At block 140, based, at least in part, on signal samples having values representing one or more CBSs, affordability assessment server 102 may compute a creditworthiness index. In embodiments, a creditworthiness index may be computed using one or more CBSs as well as personal identification parameters, which may include financial status parameters. Alternately, one or more CBSs may be used as a creditworthiness index.

In some embodiments, an affordability assessment and/or affordability certificate may be provided to individual 115 based, at least in part, on the individual's creditworthiness being estimated to be above a threshold value. Likewise, in an embodiment in which one or more CBSs are used as a creditworthiness index, an individual's one or more CBSs (which may be combined in an embodiment, such as an average, for example) may be above a threshold value. Accordingly, at block 145, responsive to a determination that the individual's creditworthiness lies above a threshold, a decision may be made as to whether individual 115 has sufficient creditworthiness, based at least in part on computation of a creditworthiness index, to purchase house 105, for example. If an individual's computed creditworthiness lies above a threshold value, server 102 may transmit an affordability certificate and/or affordability assessment to mobile device 110, such as at block 150. In embodiments, an affordability certificate and/or affordability assessment may be retransmitted by an individual a realtor and/or other agent representing a seller of house 105. Alternatively, permission may be sought for server 102 to transmit an affordability certificate and/or affordability assessment to a realtor or other agent, for example. In an implementation, an affordability certificate or affordability assessment may indicate an individual's interest in purchasing house 105, for example, and/or an individual's likelihood of being able to secure appropriate funding.

If decision block 145 indicates that the creditworthiness index of individual 115 is estimated to be below a threshold value, server 102 may determine that an individual may be unlikely to secure funding to purchase house 105, for example. In one or more possible embodiments, decision block 145 may involve estimating whether a creditworthiness index lies below a threshold value, such as below a score of 70 on a scale of 100, just to name one possible example. However, in at least one other embodiment, decision block 145 may possibly involve estimating whether creditworthiness lies in a range, such as between 65 and 70 on a scale of 100, for example. Responsive to determining or estimating that a creditworthiness index approaches a threshold value, or lies within a range, block 155 may be performed in which affordability assessment server 102 may transmit an offer for credit restoration, if appropriate. For example, in one or more embodiments, credit restoration may not be extendable to individuals having certain ranges of credit scores, such as a FICO score of below 600, for example. Thus, in one or more embodiments, affordability assessment server may transmit a message comprising a question as to whether an individual wishes to improve his or her credit. In one or more other embodiments, a message may be transmitted indicating that affordability is unable to be determined, or that the individual may wish to contact a lender, for example. However, in general, offers may be useful to individual 115 in positioning the individual for a future purchase of, for example, house 105 or a similar property, for example, perhaps after undertaking credit restoration measures. For example, a determination creditworthiness lies within a range may generate one or more electronic transmissions, such as emails, for example, providing examples of affordable houses similar to the house indicated by the individual to be of interest, although the house of interest may have been determined to not be affordable based at least in part on the creditworthiness index.

In one or more embodiments, an individual may enter into an agency relationship with an owner, for example, of affordability assessment server 102 to permit credit inquiries (e.g., soft inquiries) on behalf of the individual. An agency relationship may be created by an individual interacting, for example, with an affordability assessment and/or affordability certification website in which the individual may elect to permit CRB report queries on his or her behalf, which may include a CBS. Likewise, as illustrated, for example, by FIG. 3, in an embodiment, an individual may also elect to permit sharing one or more CBSs, such as via clicking a box to grant permission to do so or granting permission via another type of user interaction. In one or more embodiments, an individual may elect to permit sharing of a measure that may be derived from a CBS, such as a credit score grade, and/or derived from a CRB report, for example.

In one or more embodiments, affordability assessment server 102 may operate on behalf of, or under the direction of, a title company, a real estate firm, and/or any other entity in connection with sale, purchase, funding, and/or other activity in connection with obtaining credit for a large expenditure, such as purchase house 105, for example. A relationship, such as an exclusive relationship, between or among one or more title companies and an owners of affordability assessment server 102 may represent a benefit in that potentially qualified buyers of house 105 may be identified and evaluated prior to presenting an offer, for example, to a seller of house 105.

In one or more embodiments, affordability assessment server 102 may operate to compute a single affordability assessment and/or affordability certificate responsive to receipt of a query and personal identification parameters, including financial status parameters, and so forth from one or from a plurality of individuals 115. For example, if a married couple, or other set of more than one individual is interested in making a purchase representing a large expenditure, such as house 105, the individuals may submit parameters requested at blocks 120, 125, and 130. At block 140, one or more obtained CBSs may be utilized to compute a creditworthiness index for the more than one individual. In one possible embodiment, a creditworthiness index may be at least partially representative of the least-creditworthy individual or, in another possible embodiment, may be representative of the most-creditworthy individual. In one or more other possible embodiments, a creditworthiness index may be computed based, at least in part, on an aggregation of creditworthiness indices for the individuals, for example. In computing a creditworthiness index for more than one individual, creditworthiness of certain individuals may be weighted differently than creditworthiness of other individuals in an embodiment, as well.

It should be noted that affordability assessment server 102 may also initiate queries to sources other than CRB 160. For example, affordability assessment server 102 may generate and/or transmit queries to background screening agencies, such as Equadata, ChoicePoint, CSIdentity, CoreLogic, etc., to obtain, for example, auto insurance scores, criminal histories, evictions, professional license searches, employment verifications, rental verifications, and so forth.

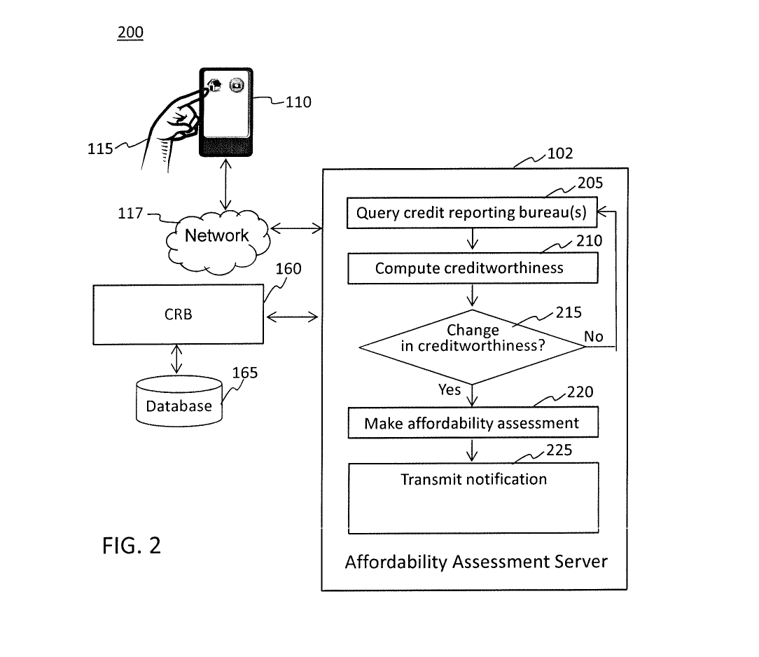

FIG. 2 is a schematic illustration of a mobile device interacting with an affordability assessment server to obtain a notification of a change in an affordability assessment and/or creditworthiness according to an embodiment 200. In the embodiment of FIG. 2, perhaps in response to a determination that individual 115 does not possess sufficient creditworthiness to be likely to secure funding for a purchase representing a large expenditure, individual 115 may seek to restore creditworthiness. In an embodiment, an individual may benefit from receiving electronic communications, such as emails, for example, regarding affordable houses for which the individual may qualify for credit, despite not having sufficient creditworthiness for a particular house of interest.

The method of FIG. 2 may begin at block 205, in which affordability assessment server 102 may execute one or more soft inquiries (e.g., on behalf of individual 115), such as by querying CRB 160. Likewise, it is noted that FIG. 2 includes blocks, such as 205-225, in a flowchart-type form for an example embodiment. Of course, embodiments in accordance with claimed subject matter may include all of blocks 205-225, fewer than blocks 205-225, or more than blocks 205-225. Also, the order of blocks 205-225, depicted in FIG. 2, is merely an example order, and claimed subject matter is not limited in scope in these respects.

In embodiments, a query from affordability assessment server 102 may comprise a soft inquiry, which may preserve integrity of the individual's CBS, as previously explained. Responsive to receipt of a CBS, block 210 may be performed in which server 102 may compute (e.g., re-compute) creditworthiness of individual 115. Block 210 may involve computing (e.g., re-computing) creditworthiness for individual 115. For example, a change may occur in one or more financial status parameters (e.g., an increase in salary) and/or a change may occur in one or more personal identification parameters, such as correction of an invalid Social Security number, as examples. Block 210 may, therefore, involve computing (e.g., re-computing) creditworthiness, although claimed subject matter is not limited in this respect.

At block 215, a creditworthiness index may be computed (e.g., re-computed) at block 210. For example, an increase may occur in creditworthiness, such as beyond a threshold value, for example. If computed creditworthiness (e.g., re-computed creditworthiness) approaches or exceeds a threshold, block 220 may be executed, in which an affordability assessment may be made. If, on the other hand, computed creditworthiness (e.g., re-computed creditworthiness) does not approach a threshold value, block 205 may be performed again at a later time, such as after one week, one month, or after another appropriate interval has passed. At block 225, a notification regarding a change creditworthiness index may be transmitted to individual 115. In embodiments, affordability assessments and/or creditworthiness indices may be transmitted utilizing an electronic-mail system, for example. In one or more embodiments, however, affordability assessment and/or creditworthiness index may likewise be transmitted to individual 115 via an SMS text message, a computer-generated voicemail, or by way of any other “push” technology in which communication is initiated by, or on behalf of, affordability assessment server 102. In one or more embodiments, individual 115 may interact with server 102, such as by way of the Internet, for example, to obtain or “pull” a notification of change in an affordability assessment and/or creditworthiness index. In one possible embodiment, a notification regarding a change in affordability may be accompanied by parameters that refer to a purchase, such as house 105 (of FIG. 1) or, perhaps a house having comparable features and/or a comparable sale price.

Likewise, as previously alluded to, in an embodiment, individual 115 may interact with a website available on the World Wide Web, which may permit the individual to periodically, and/or as desired, check his or her creditworthiness from time to time. A cookie may be utilized to permit individual 115 to access his or her creditworthiness index and/or affordability assessment without requiring the individual to enter, for example, user name, login identification, password, and so forth. Accordingly, an individual may monitor his or her creditworthiness and/or affordability assessment without necessarily supplying an electronic-mail address. It should be noted that claimed subject matter is intended to embrace all techniques for permitting an individual to occasionally and/or to periodically obtain up-to-date creditworthiness and/or affordability indications, without limitation, by accessing, and/or by receiving electronic transmissions from, affordability assessment server 102, for example.

It should be noted that although the embodiment of FIG. 2 is described in the context of affordability assessment server 102 executing one or more soft inquiries, in one or more other embodiments, block 205 may be replaced, for example, by an updated CBS being made available to server 102 by CRB 160. In one or more other embodiments, block 205 may be executed, for example, responsive to individual 115 supplying updated financial status parameters that relate to the individual's financial condition, such as a change in monthly income, monthly debt, and so forth. In one or more other embodiments, block 205 may be executed responsive to, for example, individual 115 completing a credit restoration program.

FIGS. 3A, 3B, 3C, 3D, 3E, and 3F are illustrations of a menu-driven interface according to an embodiment 300. It should be noted that FIGS. 3A, 3B, 3C, 3D, 3E, and 3F comprise an illustration of merely one possible embodiment out of a myriad of possible embodiments of an interface, which may be displayed on a mobile device, such as mobile device 110 of FIGS. 1 and 2, for example. Additionally, although a number of fields, such as MLS entry field 310, have been identified in FIGS. 3A, 3B, 3C, 3D, 3E, and 3F, claimed subject matter is not limited to any particular number of fields, arrangement of fields, naming of fields, and so forth. Further, FIGS. 3A, 3B, 3C, 3D, 3E, and 3F comprise an illustration of an embodiment of an interface of mobile device, such as 110 (e.g., a “front end” interface). FIGS. 3A, 3B, 3C, 3D, 3E, and 3F do not include an interface which may appear at a “back end,” such as at affordability assessment server 102, which may be utilized to initiate electronic-mail notifications of one or more properties, such as properties corresponding to an individual's affordability, for example.

In FIG. 3A, a “Welcome” screen is displayed in which a user, such as individual 115, may enter an identifier. For example, a Nationwide Mortgage Licensing System (NMLS) number may be entered by a realtor. In one or more other embodiments, in which a NMLS is not supplied, a real estate agent may send a link to mobile device 110, which may permit an individual to complete a process to assess home affordability aside from utilizing a menu-driven interface, such as embodiment 300, for example. In one or more embodiments, a link supplied by a real estate agent may provide identifying parameters such as an NMLS and/or additional parameters which may indicate which real estate agent is responsible for the NMLS.

To continue to the screen of FIG. 3B, the individual may select “Continue,” such as by ‘clicking’ or by any other user interaction, In FIG. 3B, an individual may enter desired property parameters, such as a ZIP code, which may bring about real estate listings, for example, of properties available within or proximate to the entered ZIP code. FIG. 3B may additionally include a selection to “Use Current Location,” which may initiate location estimation utilizing one or more satellites from a satellite positioning system, such as the Global Positioning System, for example. FIG. 3B may additionally include a selection to “Use Image Recognition” in which an image of an item of real estate, such as house 105 of FIG. 1, may be captured by a camera under control of mobile device 110, for example. Keypoints and/or features of house 105 may be compared with reference images of a database of captured images and parameters of a corresponding house for sale, for example, may be transmitted to the mobile device. FIG. 3B may also include a selection for accepting an entry, such as to desired age of a home being sought and/or other descriptive parameters, such as, for example to search a database of available properties for sale.

In FIG. 3C, personal identification parameters, such as first name, last name, electronic-mail address, phone number, and address of an individual may be entered. At FIG. 3D financial status parameters, such as annual income, monthly expenses, prior bankruptcies and/or foreclosures, a down payment amount, additional parameters may be entered and submitted. In FIG. 3E, identity verification parameters, which may be transmitted from, for example, affordability assessment server 102 of FIGS. 1 and 2, may be displayed. Identity verification parameters may comprise one or more questions posed to an individual which other individuals, such as an identity thief, for example, may be unlikely to know. In the particular example FIG. 3E, possible questions may include an individual's knowledge of a past mobile or landline phone number assigned to the individual, an individual's knowledge of a current auto loan payment, and any number of other identity verification questions, virtually without limitation. If an individual fails verification, a more thorough verification procedure may be initiated, such as a phone call, for example. In FIG. 3F, an affordability assessment and/or affordability certificate may be displayed along with an individual's affordability ranking with respect to other consumers, a creditworthiness index, and an affordability amount, which may, for example, indicate an upper limit and/or upper range of price for a house that the individual is likely to be capable of affording. FIG. 3F may additionally display a selection to forward or share one or more parameters with a real estate agent, lender, seller, and/or a variety of other parties, such as permission to share one or more CBSs, for example.

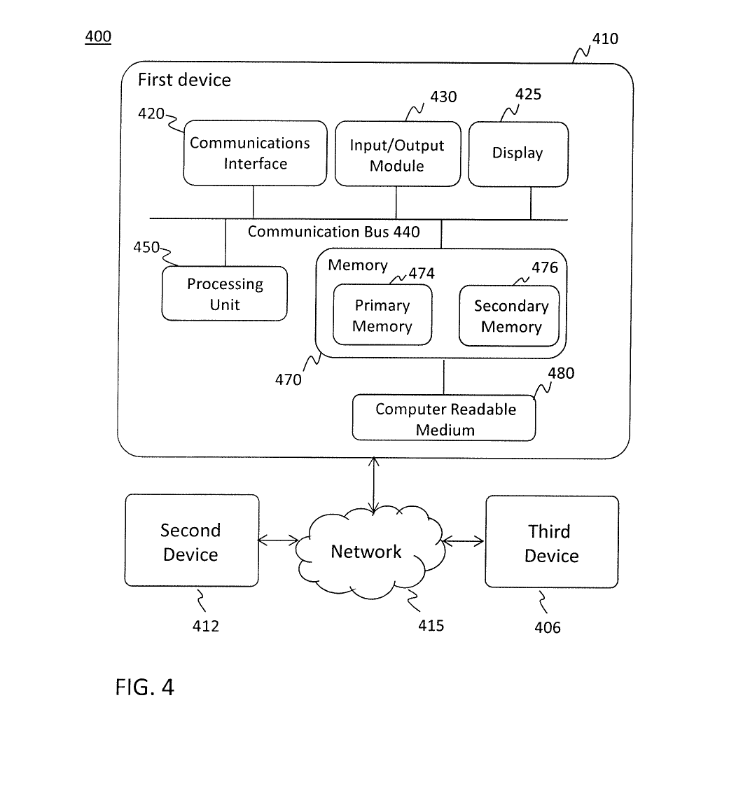

For purposes of illustration, FIG. 4 is an illustration of an embodiment 400 of a system that may be employed in a client-server type interaction, such as described infra. in connection with obtaining an affordability assessment and/or affordability certificate using mobile computing device 110 of FIGS. 1 and 2, for example. In FIG. 4, computing device 410 (‘first device’ in figure) may interface with mobile client 412 (‘second device’ in figure), which may comprise features of a mobile client computing device, for example. Communications interface 420, processor (e.g., processing unit) 450, and memory 470, which may comprise primary memory 474 and secondary memory 476, may communicate by way of communication bus 440, for example. In FIG. 4, mobile client computing device 412 may represent one or more sources of analog, uncompressed digital, lossless compressed digital, and/or lossy compressed digital formats for content of various types, such as video, imaging, text, audio, etc. in the form physical states and/or signals, for example. Mobile client computing device 412 may communicate with computing device 410 by way of a connection, such as an internet connection, via network 415, for example. Although computing device 410 of FIG. 4 shows the above-identified components, claimed subject matter is not limited to computing devices having only these components as other implementations may include alternative arrangements that may comprise additional components or fewer components, such as components that function differently while achieving similar results. Rather, examples are provided merely as illustrations. It is not intended that claimed subject matter to be limited in scope to illustrative examples.

Processing unit 450 may be representative of one or more circuits, such as digital circuits, to perform at least a portion of a computing procedure and/or process. By way of example, but not limitation, processing unit 450 may comprise one or more processors, such as controllers, microprocessors, microcontrollers, application specific integrated circuits, digital signal processors, programmable logic devices, field programmable gate arrays, the like, or any combination thereof. In implementations, processing unit 450 may perform signal processing to manipulate signals and/or states, to construct signals and/or states, etc., for example.

Memory 470 may be representative of any storage mechanism. Memory 470 may comprise, for example, primary memory 474 and secondary memory 476, additional memory circuits, mechanisms, or combinations thereof may be used. Memory 470 may comprise, for example, random access memory, read only memory, etc., such as in the form of one or more storage devices and/or systems, such as, for example, a disk drive, an optical disc drive, a tape drive, a solid-state memory drive, etc., just to name a few examples. Memory 470 may be utilized to store a program. Memory 470 may also comprise a memory controller for accessing computer readable-medium 480 that may carry and/or make accessible content, which may include code, and/or instructions, for example, executable by processing unit 450 and/or some other unit, such as a controller and/or processor, capable of executing instructions, for example.

Under direction of processing unit 450, memory, such as memory cells storing physical states, representing, for example, a program, may be executed by processing unit 450 and generated signals may be transmitted via the Internet, for example. Processing unit 450 may also receive digitally-encoded signals from mobile client computing device 412.

Network 415 may comprise one or more network communication links, processes, services, applications and/or resources to support exchanging communication signals between a mobile client computing device, such as 412, and computing device 406 (‘third device’ in figure), which may, for example, comprise one or more servers (not shown). By way of example, but not limitation, network 415 may comprise wireless and/or wired communication links, telephone and/or telecommunications systems, Wi-Fi networks, Wi-MAX networks, the Internet, a local area network (LAN), a wide area network (WAN), or any combinations thereof.

The term “computing device,” as used herein, refers to a system and/or a device, such as a computing apparatus, that includes a capability to process (e.g., perform computations) and/or store content, such as measurements, text, images, video, audio, etc. in the form of signals and/or states. Thus, a computing device, in this context, may comprise hardware, software, firmware, or any combination thereof (other than software per se). Mobile computing device 110, as depicted in FIG. 1, is merely one example, and claimed subject matter is not limited in scope to this particular example. For one or more embodiments, a computing device may comprise any of a wide range of digital electronic devices, including, but not limited to, personal desktop and/or notebook computers, high-definition televisions, digital versatile disc (DVD) players and/or recorders, game consoles, satellite television receivers, cellular telephones, wearable devices, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 470 may store cookies relating to one or more users and may also comprise a computer-readable medium that may carry and/or make accessible content, including code and/or instructions, for example, executable by processing unit 450 and/or some other unit, such as a controller and/or processor, capable of executing instructions, for example. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

Regarding aspects related to a communications and/or computing network, a wireless network may couple mobile client devices with a network. A wireless network may employ stand-alone ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including Long Term Evolution (LTE), WLAN, Wireless Router (WR) mesh, 2nd, 3rd, or 4th generation (2G, 3G, or 4G) cellular technology and/or the like. Network access technologies may enable wide area coverage for devices, such as client devices with varying degrees of mobility, for example.

A network may enable radio frequency and/or wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or other, or the like. A wireless network may include virtually any type of now known, or to be developed, wireless communication mechanism by which signals may be communicated between devices, such as a client device or a computing device, between or within a network, or the like.

Communications between a computing device and/or a network device and a wireless network may be in accordance with known and/or to be developed communication network protocols including, for example, global system for mobile communications (GSM), enhanced data rate for GSM evolution (EDGE), 802.11b/g/n, and/or worldwide interoperability for microwave access (WiMAX). A computing device and/or a networking device may also have a subscriber identity module (SIM) card, which, for example, may comprise a detachable smart card that is able to store subscription content of a user, and/or is also able to store a contact list of the user. A user may own the computing device and/or networking device or may otherwise be a user, such as a primary user, for example. A computing device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a communication network may be embodied as a wired network, wireless network, or any combinations thereof.

A device, such as a computing and/or networking device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

A computing and/or network device may include and/or may execute a variety of now known and/or to be developed operating systems, derivatives and/or versions thereof, including personal computer operating systems, such as a Windows, iOS, Linux, a mobile operating system, such as iOS, Android, Windows Mobile, and/or the like. A computing device and/or network device may include and/or may execute a variety of possible applications, such as a client software application enabling communication with other devices, such as communicating one or more messages, such as via protocols suitable for transmission of email, short message service (SMS), and/or multimedia message service (MMS), including via a network, such as a social network including, but not limited to, Facebook, LinkedIn, Twitter, Flickr, and/or Google+, to provide only a few examples. A computing and/or network device may also include and/or execute a software application to communicate content, such as, for example, textual content, multimedia content, and/or the like. A computing and/or network device may also include and/or execute a software application to perform a variety of possible tasks, such as browsing, searching, playing various forms of content, including locally stored and/or streamed video, and/or games such as, but not limited to, fantasy sports leagues. The foregoing is provided merely to illustrate that claimed subject matter is intended to include a wide range of possible features and/or capabilities.

A network may also be extended to another device communicating as part of another network, such as via a virtual private network (VPN). To support a VPN, broadcast domain signal transmissions may be forwarded to the VPN device via another network. For example, a software tunnel may be created between a logical broadcast domain, and a VPN device. Tunneled traffic may, or may not be encrypted, and a tunneling protocol may be substantially compliant with and/or substantially compatible with any now known and/or to be developed versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, another existing protocol, and/or another protocol that may be developed.

A virtual private network (VPN) may enable a remote device to more securely (e.g., more privately) communicate via a local network. A router may allow network communications in the form of network transmissions (e.g., signal packets and/or frames), for example, to occur from a remote device to a VPN server on a local network. A remote device may be authenticated and a VPN server, for example, may create a special route between a local network and the remote device through an intervening router. However, a route may be generated and/or also regenerate if the remote device is power cycled, for example. Also, a VPN typically may affect a single remote device, for example, in some situations.

Typically, a network protocol, such as protocols characterized substantially in accordance with the aforementioned OSI model, has several layers. These layers may be referred to here as a network stack. Various types of network transmissions may occur across various layers. A lowest level layer in a network stack, such as the so-called physical layer, may characterize how symbols (e.g., bits and/or bytes) are transmitted as one or more signals over a physical medium (e.g., twisted pair copper wire, coaxial cable, fiber optic cable, wireless air interface, combinations thereof, etc.). Progressing to higher-level layers in a network protocol stack, additional operations may be available by initiating network transmissions that are compatible and/or compliant with a particular network protocol at these higher-level layers. Therefore, for example, a hardware bridge, by itself, may be unable to forward signal packets to a destination device since transmission of signal packets characterized at a higher-layer of a network stack may not be supported by a hardware bridge. Although higher-level layers of a network protocol may, for example, affect device permissions, user permissions, etc., a hardware bridge, for example, may typically provide little user control, such as for higher-level layer operations.

It will, of course, be understood that, although particular embodiments will be described, claimed subject matter is not limited in scope to a particular embodiment and/or implementation. For example, one embodiment may be in hardware, such as implemented to operate on a device or combination of devices, for example, whereas another embodiment may be, at least in part, in software. Likewise, an embodiment may be implemented in firmware, or as any combination of hardware, software, and/or firmware, for example (other than software per se). Likewise, although claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, or other system, for example, that may result in an embodiment of a method in accordance with claimed subject matter being executed, such as a previously described embodiment, for example; although, of course, claimed subject matter is not limited to previously described embodiments. As one potential example, a computing platform may include one or more processing units or processors, one or more devices capable of inputting/outputting, such as a display, a keyboard and/or a mouse, and/or one or more memories, such as static random access memory, dynamic random access memory, flash memory, and/or a hard drive.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms, and/or symbolic representations of operations on binary signals and/or states, such as stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
executing instructions utilizing one or more processors of a computing device to: compute an affordability assessment for an individual based at least in part on a credit reporting bureau (CRB) report query executed via electronic transmission and in a manner that preserves integrity of a credit bureau score (CBS) for the individual.

2. The method of claim 1, wherein the query comprises a soft credit score inquiry.

3. The method of claim 2, wherein the soft credit score inquiry comprises an inquiry executed by an agent on behalf of the individual.

4. The method of claim 2, wherein the soft credit score inquiry comprises a self-inquiry.

5. The method of claim 1, wherein the affordability assessment for credit comprises assessment for issuance of a credit card.

6. The method of claim 1, wherein the affordability assessment comprises an assessment for credit or a loan.

7. The method of claim 6, wherein the assessment for credit or a loan comprises an assessment for a loan for purchase of at least one of the following: a house, an automobile, a boat, and/or a business.

8. The method of claim 7, wherein the assessment for the loan relates to a purchase of a house, wherein the house is identified by using at least one of: a street address, a ZIP code, at least one captured image one or more visual features of the exterior of the house, and/or a location of the house estimated utilizing one or more signals from a satellite positioning system.

9. The method of claim 8, further comprising:
executing instructions utilizing one or more processors of the computing device to:
transmit one or more messages through an electronic-mail system, the one or more messages representing parameters for at least one other house, based, at least in part, on a determination that an approximate purchase price of the at least one other house is less than or equal to an affordability amount.

10. The method of claim 1, further comprising:
executing instructions utilizing one or more processors of the computing device to:
obtain an input signal, from a user interface, representing a request from the individual to transmit the individual's affordability assessment to an agent of a seller or buyer.

11. The method of claim 1, further comprising:
executing instructions utilizing one or more processors of the computing device to:
transmit one or more messages relating to credit restoration based, at least in part, on the CBS approaching a threshold value.

12. An article comprising:
a non-transitory storage medium comprising instructions stored thereon executable by a special purpose computing apparatus to:
compute an affordability assessment for a purchase based at least in part an individual's creditworthiness, the creditworthiness being based, at least in part, on at least one query to a credit reporting bureau (CRB) in a manner that does not degrade the individual's credit bureau score (CBS).

13. The article of claim 12, wherein the at least one query to the CRB comprises a self-inquiry.

14. The article of claim 12, wherein the non-transitory storage medium comprises an application to execute on a mobile device.

15. The article of claim 12, wherein the instructions are further executable to:
transmit one or more messages relating to credit restoration based, at least in part, on the individual's CBS approaching a threshold value.

16. The article of claim 12, wherein the at least one query to the CRB comprises an inquiry executed by an agent on behalf of the individual.

17. The article of claim 12, wherein the affordability assessment for credit relates to obtaining credit for a loan for purchase of at least one of the following: a house, an automobile, a boat, and/or a business.

18. The article of claim 17, wherein the instructions are further executable to:
transmit one or more messages through an electronic-mail system, the one or more messages representing parameters for at least one other purchase based, at least in part, on a determination that an approximate price of the at least one other purchase is less than or equal to an amount of the loan.

19. The article of claim 12, wherein the instructions are further executable to:
obtain an input signal, from a user interface, representing a request from the individual to transmit the individual's affordability assessment to an agent of a seller.

20. The article of claim 12, wherein the affordability assessment relates to obtaining credit for purchase of a house, and wherein the instructions are further executable to:
identify the house by utilizing at least one of: a street address, at least one captured image one or more visual features of the exterior of the house, and/or a location of the house estimated utilizing one or more signals from a satellite positioning system.

21. The article of claim 12, wherein the at least one query to the CRB comprises a soft inquiry for a CBS, a credit report, a summarized credit profile, a credit summary, a risk measurement, or any combination thereof.

22. A system comprising:
one or more computing devices to generate an affordability assessment and/or affordability certificate for an individual based at least in part on a query to one or more credit reporting bureaus (CRBs) executed via electronic transmission and in a manner that preserves integrity of the one or more credit bureau scores (CBSs).

23. The system of claim 22, wherein the query to the one or more CRBs comprises a soft credit score inquiry.

24. The system of claim 23, wherein the soft credit score inquiry comprises an inquiry executed by an agent on behalf of the individual.

25. The system of claim 23, wherein the soft credit inquiry comprises a self-inquiry initiated by the individual interacting with a mobile device.

26. The system of claim 22, wherein the affordability assessment and/or affordability certificate is based, at least in part, on the individual's creditworthiness.

27. The system of claim 26, wherein the affordability assessment or affordability certificate relates to the individual's creditworthiness to obtain a loan for purchase of at least one of the following: a house, a vehicle, and/or a business.

28. The system of claim 27, wherein the affordability assessment and/or affordability certificate for the loan comprises credit for a loan for purchase of a house, wherein the system further comprises:
at least one database for matching key points extracted from a captured image of a house with a reference image stored in the at least one database.

29. The system of claim 27, wherein the affordability assessment and/or affordability certificate for the loan comprises credit for a loan for purchase of a house, wherein the system further comprises:
at least one real estate database for matching an estimated location of a house with location parameters stored in the at least one real estate database.

30. The method of claim 27, wherein the affordability assessment and/or affordability certificate for the loan comprises credit for a loan for purchase of a house, wherein the system further comprises:
at least one real estate database for matching a quick response code with location parameters stored in the at least one real estate database.

31. A method comprising, at a mobile device:
executing instructions utilizing one or more processors of the mobile device to: initiate a query for an affordability assessment, the affordability assessment to be for an individual and to be based at least in part on one or more queries to a credit reporting bureau (CRB) executed via electronic transmission and in a manner that preserves integrity of the one or more CBSs.

32. The method of claim 31, further comprising:
executing instructions utilizing one or more processors of the mobile device to: accept a verification from an interface for the mobile device that a reference image corresponds to a house in view of the mobile device.

33. The method of claim 31, further comprising:
executing instructions utilizing one or more processors of the mobile device to: transmit an estimated location for the mobile device; and receive at least one of a physical address, image, and sale price for a house that matches the estimated location.

34. A mobile device comprising:
a special purpose computing apparatus to initiate a query to an affordability assessment server; and to receive an affordability assessment for a purchase to be based at least in part an individual's creditworthiness, the creditworthiness to be based, at least in part, on a soft inquiry to a credit reporting bureau (CRB), the soft inquiry to preserve integrity of the individual's credit bureau score (CBS).

35. The mobile device of claim 34, wherein the at least one query to the CRB to comprise a self-inquiry to be initiated via electronic transmission from the mobile device.

36. The mobile device of claim 34, wherein the instructions are further executable to:
grant permission to transmit the individual's affordability assessment to a third-party.
